(19) United States
(12) Patent Application Publication
(10) Pub. No.: US 2011/0097468 A1
(43) Pub. Date: Apr. 28, 2011

(54) Rotisserie chili roaster

(76) Inventors: Patrick I. Driscoll, Fountain Hills, AZ (US); Cindy L. Myers, Fountain Hills, AZ (US)

(21) Appl. No.: 12/801,692

(22) Filed: Jun. 21, 2010

Related U.S. Application Data
(60) Provisional application No. 61/272,746, filed on Oct. 28, 2009.

(51) Int. Cl. A47J 37/04; A47J 37/07; A23L 1/01

(52) U.S. Cl. 426/519; 99/450; 99/339

(57) ABSTRACT

The rotisserie chili roaster includes a cylindrical perforated cage having opposite open ends capped by a cover. The perforated cage includes a door panel pivotally attached to the cage by a hinge mechanism. The door panel is selectively closed by a latch mechanism. Each cover includes a centrally disposed collar having a bore therethrough, and a locking mechanism is operatively attached thereto. A rotatable rod is inserted through the collars and locked by the locking mechanism. A plurality of chili or other food products may be placed inside the cage, and the rod may be operatively attached to a motor or a handle such that rotation of the rod concurrently rotates the cage placed over a source of heat to thereby roast the food products.

### CROSS-REFERENCE TO RELATED APPLICATION

This application claims the benefit of U.S. Provisional Patent Application Ser. No. 61/272,746, filed Oct. 28, 2009.

### FIELD OF THE INVENTION

The present invention relates to cooking accessories, and more particularly to a rotisserie chili roaster for convenient and easy roasting of chili and other food products.

### DESCRIPTION OF THE RELATED ART

Roasting over an open fire is an ancient method of cooking food. It imparts a smoky flavor that many people enjoy. Nowadays, this type of cooking may be duplicated with barbeque grills, which is a favorite past time for interacting with friends and family.

For those who like the taste and flavor of roasted chili such as Anaheims, Poblanos, jalapenos, green or red peppers, etc., roasting these chili can be a time consuming process. Typically, this involves placing individual chili over an open flame and turning it over periodically to char the skin and ensuring even cooking. However, this requires constant monitoring from the cook, and some care must be exercised to prevent accidental burning to oneself as well as the food. Another method involves using an oven, but that detracts from imparting a smoky flavor to the roasted chili. Moreover, ovens are not energy efficient. Thus, it would be a benefit in the art to provide a device or method that roasts chili or other food products in an efficient manner.

Thus, a rotisserie chili roaster solving the aforementioned problems is desired.

### SUMMARY OF THE INVENTION

The rotisserie chili roaster includes a cylindrical perforated cage having opposite open ends capped by a cover. The perforated cage includes a door panel pivotally attached to the cage by a hinge mechanism. The door panel is selectively closed by a latch mechanism. Each cover includes a centrally disposed collar having a bore therethrough and a locking mechanism is operatively attached thereto. A rotatable rod is inserted through the collars and locked by the locking mechanism. A plurality of chili or other food products may be placed inside the cage, and the rod may be operatively attached to a motor or a handle such that rotation of the rod concurrently rotates the cage placed over a source of heat to thereby roast the food products.

These and other features of the present invention will become readily apparent upon further review of the following specification and drawings.

### BRIEF DESCRIPTION OF THE DRAWINGS

FIG. 1 is an environmental, perspective view of a rotisserie chili roaster according to the present invention.

FIG. 2 is a perspective view of the rotisserie chili roaster according to the present invention.

FIG. 3 is a front view of the rotisserie chili roaster according to the present invention.

FIG. 4 is a side view of the rotisserie chili roaster according to the present invention.

Similar reference characters denote corresponding features consistently throughout the attached drawings.

### DETAILED DESCRIPTION OF THE PREFERRED EMBODIMENTS

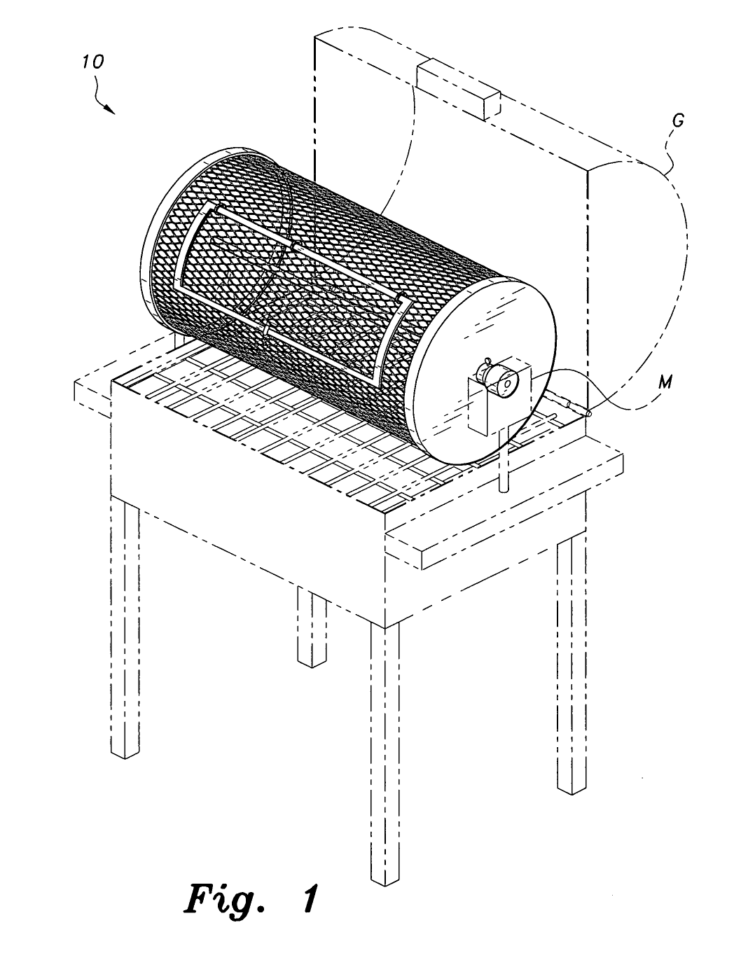

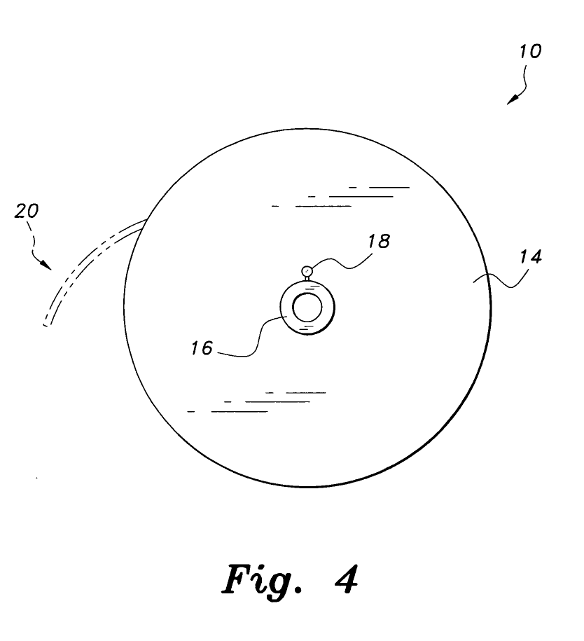

The present invention relates to a rotisserie chili roaster, generally referred to by reference number 10 in the drawings, for convenient and easy roasting of a plurality of chili, vegetables, fruit and other food products. As shown in FIGS. 1-4, the rotisserie chili roaster 10 includes a substantially cylindrical basket or cage 12 for holding the chili or food products therein. The cage 12 is perforated to allow heat induction for roasting. The cage 12 may be made from a wire or metal mesh, e.g., expanded metal. The opposite open ends of the cage 12 include a respective cover 14 formed from a solid circular plate to thereby provide an enclosure keeping the food therein.

Each cover 14 includes a centrally disposed collar 16 with a throughbore to accommodate insertion of a rotatable bar, rod, shaft or axle 34. To ensure that the cylindrical cage 12 does not rotate freely relative to the bar 34, each collar 16 includes a locking mechanism 18 for locking the cage 16 relative to the bar 34. The locking mechanism 34 may be a thumbscrew that clamps the bar 34 inside the collar 16 using an internally threaded side bore, but other similar locking mechanisms may also be used, e.g., a locking pin, a collar clamp, etc.

To load the rotisserie chili roaster 10 with chili or other food products, the cage 12 includes a pivotable door panel or gate 20 on a side thereof. The gate 20 may comprise a curved, substantially rectangular frame 22 supporting a panel 28 with matching perforations. A pivot mechanism 24 is attached to one side of the gate 20 to facilitate selective opening and closing of the gate 20. The pivot mechanism 24 is preferably a plurality of hinges but other similar means may be used in place thereof. A latch mechanism 26 is disposed on the opposite side of the gate 20 to selectively lock the same for the roasting operation.

There are a couple of different ways to operate the rotisserie chili roaster 10. One involves utilizing a typical barbeque grill. As shown in FIG. 1, the rotisserie chili roaster 10 is mounted to a barbeque grill G over the coals or heat source. One end of the bar 34 is operatively attached to a motor M. Chili or other food products may be loaded inside the cage 12 through the open gate 20 and then latched closed. Activation of the motor M allows for automated rotation of the rotisserie chili roaster 10 leaving the user time to socialize or complete other tasks.

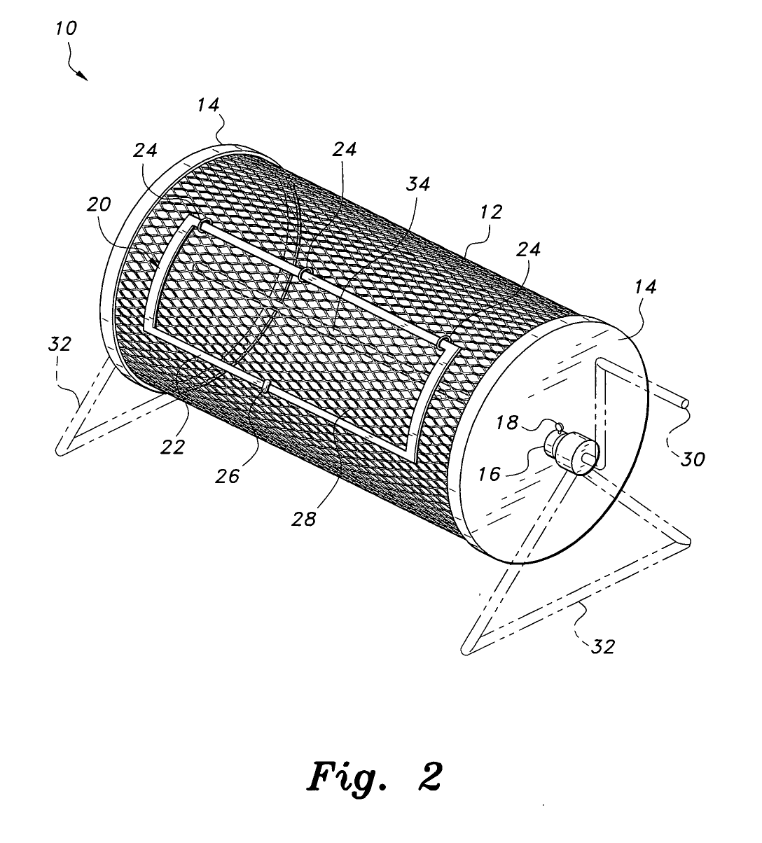

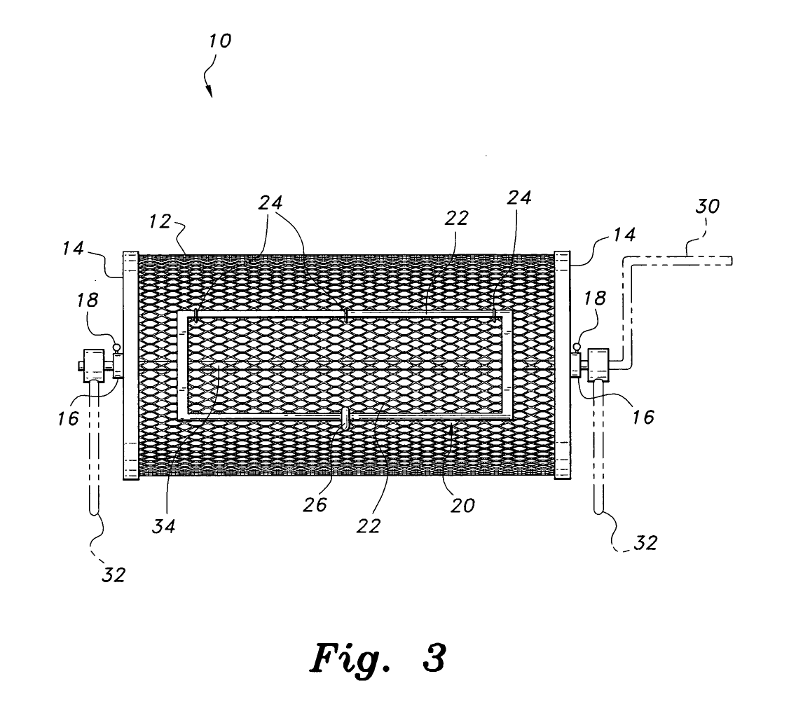

A manual method of using the rotisserie chili roaster 10 is shown in FIGS. 2 and 3. In this method, the rotisserie chili roaster 10 is mounted to support stands 32 over a heat source. A crank handle is attached to one end of the bar 34 so that the user may manually rotate the rotisserie chili roaster 10.

With both methods, the rotation of the rotisserie chili roaster 10 causes the chili or food products to tumble inside the cage 12. The tumbling action ensures even cooking and roasting of the food products and imparts a pleasurable smoky flavor to the food depending on the heat source. In addition, the roasted chili or vegetable is easier to peel.

Thus, it can be seen that the rotisserie chili roaster 10 is a convenient means for roasting chili and other food products. The food may be roasted in relatively large batches with minimal monitoring for even and flavorful cooking.

It is noted that the rotisserie chili roaster 10 encompasses a wide variety of alternatives. For example, the rotisserie chili roaster 10 is preferably made from steel, but other heat conductive materials are viable alternatives. Moreover, the rotisserie chili roaster 10 may be provided with or without a bar 34, especially for users with grills that have included roasting bar attachments. Furthermore, the rotisserie chili roaster 10 may include a plurality of selectively mountable skewers for roasting meats and vegetables in a kabob style.

It is to be understood that the present invention is not limited to the embodiments described above, but encompasses any and all embodiments within the scope of the following claims.

I claim:

1. A rotisserie chili roaster, comprising:
a cylindrical perforated cage adapted for holding food products therein;
a cover disposed at opposing ends of the cylindrical perforated cage, each of the covers having:
a centrally disposed mounting collar for a rotatable bar; and
a locking mechanism for locking the bar in the collar; and
a selectively pivotal gate attached to the cage, the gate having:
a pivoting mechanism attached to one side of the gate; and
a latching mechanism to keep the gate closed, the gate forming an opening in the cage when pivoted open to permit the food products to be placed in the cage;
wherein rotation of the cage over a heat source causes the food products to tumble and roast evenly.

2. The rotisserie chili roaster according to claim 1, wherein said pivoting mechanism comprises at least one hinge.

3. The rotisserie chili roaster according to claim 1, further comprising means for selectively rotating said cage.

4. The rotisserie chili roaster according to claim 1, further comprising a motor and a rotatable bar connected to the motor, the bar being locked into said mounting collars by said locking mechanisms, the motor selectively rotating said cage, the motor being adapted for mounting to supports on a barbeque grill.

5. The rotisserie chili roaster according to claim 1, wherein further comprising a crank having a rotatable bar extending therefrom, the bar being locked into said mounting collars by said locking mechanisms, the crank and the rotatable bar being adapted for rotatable mounting in bearings attached to a barbecue grill, whereby said cage may be selectively rotated by rotating the crank.

6. The rotisserie chili roaster according to claim 1, further comprising support stands attached to said rotatable bars for supporting the cage over the heat source.

7. A method of roasting chili, comprising the steps of:
providing a perforated cylindrical cage having closed ends, a rotatable shaft insertably mounted through the closed ends, and a pivotal perforated door on the cylindrical cage;
loading the cage with chili through the door;
attaching one end of the shaft to a source of rotation power;
providing a heat source below the cylindrical cage; and
rotating the cylindrical cage to roast the chili therein.

8. A chili roaster in combination with a grill, comprising:
a cooking pit having a wire grill disposed atop the pit;
a pair of supports raised above opposite sides of the pit;
a cylindrical mesh cage having opposite ends and having an access opening defined in the mesh between the opposite ends;
a gate pivotally attached to the mesh cage, the gate being pivotal between an open position uncovering the access opening and a closed position covering the access opening;
a pair of circular end plates closing the opposite ends of the cylindrical cage, each of the end plates having a central collar extending external to the cage, each of the collars defining a central bore adapted for extending a shaft therethrough, each of the collars having an internally threaded side bore defined therein extending normal to and communicating with the central bore;
a thumbscrew extending through each of the side bores, the thumbscrews being adapted for clamping the shaft therein;
and means for rotating the cylindrical mesh cage above the cooking pit.

9. The chili roaster in combination with a grill according to claim 8, wherein said means for rotating comprises:
a motor mounted on one of said supports; and
a shaft extending from the motor and through the collars in said end plates, the shaft being clamped to said cage by said thumbscrews.

10. The chili roaster in combination with a grill according to claim 8, wherein said means for rotating comprises:
a crank mounted on one of said supports; and
a shaft extending from the crank and through the collars in said end plates, the shaft being clamped to said cage by said thumbscrews.

11. The chili roaster in combination with a grill according to claim 8, further comprising a latch attached to said cage, the latch selectively retaining the gate in the closed position.
